(19) United States
(12) Patent Application Publication
(10) Pub. No.: US 2026/0311183 A1
(43) Pub. Date: Oct. 8, 2026

(54) SYSTEMS AND METHODS FOR IMPROVED MACHINE LEARNING MODELS

(71) Applicant: JPMORGAN CHASE BANK, N.A., New York, NY (US)

(72) Inventors: Hassan OMIDI FIROUZI, Houston, TX (US); Ryan SCHMIEDL, Bradenton, FL (US); Shantanu CHANDRA, Seattle, WA (US); Ebby ABDUL, Voorhees, NJ (US)

(21) Appl. No.: 19/228,337

(22) Filed: Jun. 4, 2025

(30) Foreign Application Priority Data
Apr. 2, 2025 (IN) 202511032621

(51) Int. Cl. G06Q 20/40; G06N 20/00

(52) U.S. Cl. CPC G06Q 20/4016; G06N 20/00

(57) ABSTRACT

In some embodiments, the techniques described herein relate to a method including: receiving, from an application in operable communication with a user interface, an indication of a proposed beneficiary of a transaction that has not been executed, the transaction being associated with a financial institution, conducting, by the application, pre-processing on an identifier of the proposed beneficiary and the financial institution, selecting multiple features associated with the proposed beneficiary, the multiple features being identified by adding one feature of the multiple features and determining the higher performance of a SHAPley analysis in a validation, conducting a Bayesian hyperparameter optimization on a grid space including a depth, determining at hyperparameter set based on a focal loss function, training a machine learning model based on a hyperparameter to identify fraud based on the beneficiary account identifier, beneficiary bank identifier, and the beneficiary bank country, and blocking the transaction based on an identification of fraud.

### BACKGROUND

### 1. Field of the Invention

Aspects generally relate to systems and methods for machine learning models and artificial intelligence.

### 2. Description of the Related Art

Conventional fraud systems and methods evaluate risk only after a transaction has been initiated, allowing fraudulent actions to complete before fraud has been identified. Fraud continues to result in loss of monies, reputation, and product. However, technical systems may be implemented to reduce or eliminate fraud through financial institutions where a sending account is located. Disclosed are systems and methods may resolve these issues by enabling a computer system to assess a confidence and/or a trustworthiness of a beneficiary account before initiating a transaction. The beneficial result includes an ability to hold or block a transaction before it is initiated. Another beneficial result includes a more accurate prediction based on one or more patterns identified based on a number of dimensions such as an account, a bank, and a country. Disclosed systems and methods include incorporating multi-dimensional indicators like transaction behavior over time, account-specific risk factors like age, recency, and one or more patterns based on a bank and/or country levels. Disclosed systems thus improve efficiency and recall of present systems in determining differences between potentially fraudulent transactions and non-fraudulent transactions.

### SUMMARY

Exemplary embodiments provide systems and methods for generating a machine learning model that executes fraud detection. According to some embodiments, a method may include receiving, from an application in operable communication with a user interface, an indication of a proposed beneficiary of a transaction that has not been executed, the transaction being associated with a financial institution, conducting, by the application, pre-processing on an identifier of the proposed beneficiary and the financial institution, selecting multiple features associated with the proposed beneficiary and/or the financial institution a dataset of beneficiaries, the multiple features being identified by adding and/or removing one feature of the multiple features and determining the higher performance of a SHAPley analysis in a validation, conducting a Bayesian hyperparameter optimization on a grid space including one or more of an iteration amount, a learning rate, a depth, and a column subsampling, determining at least two hyperparameter sets based on a focal loss function, training a machine learning model based on the at least two hyperparameter sets to identify fraud based on the proposed beneficiary account identifier, beneficiary bank identifier, and the beneficiary bank country, and blocking the transaction based on an identification of fraud by the machine learning model.

Exemplary embodiments provide systems and methods for generating a machine learning model to detect anomalies. According to some embodiments, a method may include receiving, by an application executed by one or more processors, indications, conducting, by the application, pre-processing on the indications; selecting, by the application, multiple features associated with the indications; conducting, by the application, a first Bayesian hyperparameter optimization on a grid space of hyperparameters to select hyperparameter values, wherein the hyperparameters includes an iteration amount; training, by the application, a machine learning model executed by one or more processors based on the multiple features and the optimization hyperparameter; removing, by the application, one or more features of the multiple features to form an updated feature set, the one or more features to be removed being determined by the application based on importance based on a SHAPley analysis of importance of each feature; conducting, by the application, a second Bayesian hyperparameter optimization on the grid space to select updated hyperparameter values associated with the hyperparameters; validating, by the application, the machine learning model based on the at least two hyperparameter values and the updated feature set; determining, by the machine learning model, an anomaly; and performing, by an action application in communication with the application, an action based on the machine learning model determination.

In some embodiments, the method may further comprise determining, by the application, the at least two hyperparameter sets based on a focal loss function. In some embodiments, the focal loss function may be calculated based on the following equation:

$$F L ( {p}_{t} ) = - {( 1 - {p}_{t} )}^{γ} log ( {p}_{t} ) .$$

$${p}_{t} = \{ \begin{matrix}p & if y = 1 \\ 1 - p & otherwise\end{matrix} .$$

where
and γ is a focusing parameter that adjusts the rate at which examples are down-weighted.

In some embodiments, the method of hyperparameters may include a learning rate. In some embodiments, the method of hyperparameters may include a depth. In some embodiments, the method of hyperparameters may include a column subsampling. In some embodiments, the method of hyperparameters may further comprise monitoring a performance of the machine learning model based on a set of indications, and determining to retrain the machine learning model if a threshold of 0.8 is exceeded for an area under a curve of the receiver operating characteristics. In some embodiments, the method of hyperparameters may further comprise monitoring a performance of the machine learning model based on a set of indications, and determining to retrain the machine learning model if a difference of interpolated determinations differences from a known data plot at one or more peg points exceeds a threshold for a true positive rate. In some embodiments, the interpolation may be determined using a Piece-wise Cubic Hermite Interpolating Polynomial at the one or more peg points.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for generating a confidence score using machine learning, in accordance with embodiments.

FIG. 2 is a SHAP model illustrating feature importance for a machine learning model, in accordance with embodiments.

FIG. 3 are training and validation set charts of a machine learning model.

FIG. 4A is a training and validation set chart of a machine learning model, in accordance with some embodiments.

FIG. 4B is a cumulative gain chart of a machine learning model, in accordance with some embodiments.

FIG. 4C is a lift chart of a machine learning model, in accordance with some embodiments.

FIG. 5 is a method for training and validating a machine learning model in accordance with some embodiments.

FIG. 6 is a block diagram of a computing device for implementing certain aspects of the present disclosure.

### DETAILED DESCRIPTION

Embodiments generally relate to systems and methods for machine learning models.

Conventional fraud systems and methods evaluate risk only after a transaction has been initiated, allowing fraudulent actions to complete before fraud has been identified. Disclosed are systems and methods may resolve these issues by enabling a computer system to assess a confidence and/or a trustworthiness of a beneficiary account before initiating a transaction. The beneficial result includes an ability to hold or block a transaction before it is initiated. Another beneficial result includes a more accurate predictions based on one or more patterns identified based on a number of indications such as an account, a bank, and a country. Disclosed systems and methods include incorporating multi-dimensional indicators like transaction behavior over time, account-specific risk factors like age, recency, and one or more patterns based on a bank and/or country levels. Disclosed systems and methods include intelligently exploring a hyperparameter space to find one or more optimal configurations for fraud detection. Using a focal loss function in a Bayesian hyperparameter optimization and machine learning (“ML”) may help train a ML model to enhance sensitivity and/or accuracy of risk predictions. This custom loss function may allow the ML model to better identify rare but significant fraud events. This may minimize both false positives and/or false negatives. By applying these techniques and tuning them based on one or more unique properties, the ML model is more efficient and more accurate than models presently available. The ML model's outputs may be calibrated into a confidence score that may reflect risk.

Disclosed are systems and methods including receiving, from an application in operable communication with a user interface, an indication of a proposed beneficiary of a transaction that has not been executed, the transaction being associated with a financial institution, conducting, by the application, pre-processing on an identifier of the proposed beneficiary and the financial institution, selecting multiple features associated with the proposed beneficiary and/or the financial institution, the multiple features being identified by adding and/or removing one feature of the multiple features and determining the higher performance of a SHAPley analysis in a validation, conducting a Bayesian hyperparameter optimization on a grid space including one or more of an iteration amount, a learning rate, a depth, and a column subsampling, determining at least two hyperparameter sets based on a focal loss function, training a machine learning model based on the at least two hyperparameter sets to identify fraud based on the proposed beneficiary and the bank, and blocking the transaction based on an identification of fraud by the machine learning model. Disclosed systems and methods include using multiple features and conducting Bayesian hyperparameters optimization on the validation set. Once the best hyperparameter values are obtained, the final machine learning model may be tested on a test set. Using SHAPley analysis at this stage one or more features are dropped or removed, the one or more features being determined based on importance (e.g., least important features are selected for removal from the feature set). Bayesian hyperparameters optimization is then performed on the grid again to tune the hyperparameter values and again leverage the SHAPley analysis. The process of testing, tuning via Bayesian hyperparameter optimization, and validating may be iterated. The SHAPley analysis and Bayesian hyperparameter optimization may improve machine learning fraud detection model 118 by improving recall.

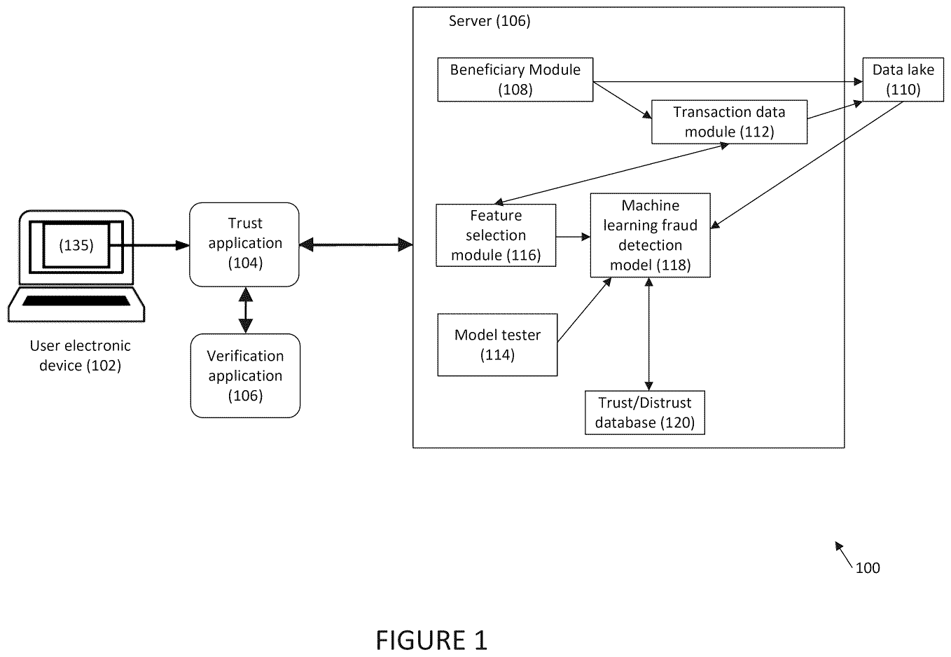

FIG. 1 is a block diagram of a system for contextual recall for machine learning models that execute fraud detection, in accordance with embodiments.

System 100 includes a user electronic device 102 executing a trust application 104 available through a user interface 135, a server 106 comprising a network or computer including a processor executing one or more software modules and a memory for storing data accessible by the one or more software modules and instructions to execute the one or more software modules. The one or more software modules may include one or more of a distrust module 108, a trust module 112, a distrust database 114, a trust database 116, and a machine learning fraud detection model 118.

The server 106 may be a server configured to provide information to one or more computers, store or manage files, and/or execute one or more module or applications. The server may be part of an institution backend. The server may be part of a cloud-based server. The server may be a computer configured to provide information to one or more other computers, store or manage files, and/or execute one or more module or applications. In some embodiments, the server 106 may include one or more databases referenced by one or more of the software modules.

In some embodiments, user electronic device 102 may be a user electronic device such as a personal communication device (e.g., tablet, phone), computer workstation, laptop, or other electronic processing device in operative communication with trust application 104 and/or server 106. User electronic device 102 may be configured to interact with trust application 104 through user interface 135. For instance, user device 102 may include a client application that allows a user of user electronic device 102 to interact with trust application 104. User interface 135 may include one or more graphical user interfaces to receive inputs and/or display information to the user. User interface 135 and/or trust application 104 may comprise one or more instructions executed by one or more processors of user electronic device 102. Trust application 104 may be a software production application provided by a service organization. In an exemplary aspect, trust application 104 may be a fraud detection application or system.

In some embodiments, trust application 104 may include an application programming interface (“API”) request (e.g., call) to communicate with server 106 to request a confidence score. In some embodiments, trust application 104 may respond to an API call with the confidence score and/or approval, allowance, or execution of a transfer. Trust application 104 may be called by a user interface on demand or when a user accesses a list of potential beneficiaries. Trust application 104 may be configured to block access to a transaction (e.g., not allow a user to access a transaction screen or not allow a user to enter transaction details) to a potential beneficiary if a confidence score is below a threshold. Trust application 104 may be configured to warn a user if a confidence score is below a threshold. Trust application 104 may be configured to execute an API call to a verification application 106 based on a user attempting to access a transaction to a proposed beneficiary, wherein the verification application 106 may be configured to execute a check on the proposed beneficiary to verify an identity of the proposed beneficiary such as through an identification verification (e.g., government-issued identification), an address verification, a two-factor authentication when accessing an account, or know-your-client verification.

Beneficiary module 108 may be a fraud screening engine. Beneficiary module 108 may process payments from payment systems every time period (e.g., every day). Beneficiary module 108 may use one or more rules, behavioral profiling, and machine learning models to identify fraud. Beneficiary module 108 may generate a fraud label for each transaction. Beneficiary module 108 may generate a fraud label for a particular type of transaction such as a wire, a type of wire, or automated clearing house (“ACH”) transaction. The type of transaction may be of an amount more than a threshold. Beneficiary module 108 may include a tree-based model. Transactions and associated fraud labels may be saved in a database (e.g., data lake 110).

Transaction data module 112 may be similar to beneficiary module 108 but transaction data module 112 may generate a fraud label for another type of transaction. For example, the other type of transaction may be through direct payments, a different kind of wire, or a wire from a different country. Additionally or alternatively, the other type of transaction may be of an amount under the threshold. Challenges with generating a score using the transaction data module 112 include a significantly larger volume of data (e.g., 10-30 times as much) and a lack of information for the transactions. The volume of data may be managed through storing and managing the data via a managed cluster platform. A managed cluster platform may be a cloud-based manager of an underlying infrastructure of a Kubernetes cluster, the manager being configured to provision resources, configure network settings, and/or operate a control plane of one or more agents of microservices efficiently. To manage the volume of data, the data may be pre-aggregated during every time period (e.g., daily) and/or may be pre-aggregated based on a reduced table. The features used by the transaction data module may include bank information and a country origin using historical data. Transactions and associated fraud labels may be saved in the database (e.g., data lake 110).

Transactions may be labeled by transaction type. Examples may be ACH transfers, U.S. wire transfers, or wire transfers from another country.

Machine learning fraud detection model 118 may apply a sliding scale of four features to each transaction. Machine learning fraud detection model 118 may determine a fraudulent beneficiary and/or a non-fraudulent beneficiary for each transaction of the data lake. Machine learning fraud detection model 118 may determine a fraudulent beneficiary and/or a non-fraudulent beneficiary for each potential transaction received from trust application 104.

Machine learning fraud detection model 118 may generate a confidence score in more than one range. For example, a range of relatively high or low numbers may indicate a low or high confidence score. An adjacent range may indicate an increase or decrease in confidence. For example, a range of 0 to 199 may indicate a low-confidence score range, a range of 200 and 599 may indicate a medium-confidence score range, and a range of 600 to 1000 may indicate a high-confidence score range.

Down-sampling techniques may be applied to data for machine learning fraud detection model 118 due to high-class imbalance. With down-sampling, the model may better distinguish between genuine and fraudulent beneficiaries by evening up the counts to produce a more accurate/focused model. A large training set for training, taken from a time period (e.g., a month, a year) of data stored in data lake 110, the machine learning fraud detection model 118 may be down-sampled so that 10% or around 10% of the large training set is fraudulent and/or the large training set may be over a period of time (e.g., a year). Further, the large training set may be refined to exclude models that were previously found to be fraudulent beneficiaries. Scores of fraudulent beneficiaries may be zero or similar to indicate they have been previously found fraudulent.

Data may be cleansed and pre-processed before being entered into the data lake 110 and/or used by machine learning fraud detection model 118. The data may be mapped in the same way before features are calculated. In some embodiments, lead zeros may be removed from one or more identifiers. In some embodiments, a translation may occur to an identifier of an expected number of digits.

The features may be formed by feature selection module 116 from transaction data module 112. For the features used to build, training, and/or validating the machine learning fraud detection model 118, feature selection may be performed by feature selection model 116. Feature selection model 116 may add and/or remove one feature at a time and compare performance in a validation set. Features may be selected based on SHAPley importance. After feature selection, feature selection model 116 may perform a Bayesian hyperparameter optimization for hyperparameter tuning of machine learning fraud detection module 118 on the following grid space:
{“iterations”: [100, 300, 500, 700, 900, 1100, 1300, 1500])},
{“learning_rate”: log uniform (log (0.001)−log (0.1))},
{“depth”: [5, 6, 7, 8, 9, 10, 11])},
{“colsample_bylevel”]=uniform (0.2-0.9)}

The above numbers are general examples and similar ranges may be expected to yield results. For example, iterations lower than 100 or a depth less than 5 may decrease a performance of the machine learning fraud detection model 118. Any more than iterations of 1500 or above a depth of 11 may similarly make the model too large where each transaction would be more costly to compute and would take longer to generate a confidence score.

The learning rate may control a step size at each iteration while moving toward a minimum of a loss function. The learning rate may directly impact the convergence speed of machine learning fraud detection model 118. Too high a learning rate may lead to overshooting the optimal solution, causing instability and divergence. Too low a learning rate may lead to overshooting the optimal solution, causing instability and divergence. Fine-tuning the learning rate may lead to convergence without excessive computation of machine learning fraud detection model 118.

The depth may control a complexity. The depth may determine how deep each tree in an ensemble may grow, impacting machine learning fraud detection model 118's ability to capture intricate patterns in the data. Too shallow a set of trees may lead to insufficient depth and underfit the data. Too deep a set of trees may lead to overfitting the training data, capturing noise, and reducing generalization to new data. Fine-tuning the depth may lead to avoiding underfitting and overfitting and thus enhancing performance of the machine learning fraud detection model 118.

The iteration may specify a number of boosting rounds. The iteration may allow the model to iteratively improve, but there is a trade-off with computation time and the risk of overfitting data for machine learning fraud detection model 118. Too few iterations may not learn enough from the data, resulting in underfitting. Too many iterations may overfit the training data, capturing noise and reducing its ability to generalize. Fine-tuning the number of iterations ensures that the machine learning fraud detection model 118 learns sufficiently from the data without excessive computation and risk of overfitting.

The column subsampling may determine a fraction of features (columns) to be used for each level in the tree. The column subsampling may directly impact randomness and helps prevent overfitting by ensuring that the model does not rely too heavily on any subset of features of machine learning fraud detection model 118. Too high a column subsampling may lead to overfitting, especially if the dataset has many features. Too low a column subsampling may lead to too few features that may limit the model's ability to capture relevant patterns, leading to underfitting. Fine-tuning the column subsampling may lead to achieving a balance, reducing overfitting while still capturing important patterns in the data by machine learning fraud detection model 118.

Feature selection model 116 may tune, via a Bayesian hyperparameter technique, a focal loss function to select optimal hyperparameters for the machine learning fraud detection model 118. The focal loss function may include a reshaped loss function to down-weight easy examples and thus focus on hard negatives. The focal loss function may be:

$$F L ( {p}_{t} ) = - {( 1 - {p}_{t} )}^{γ} log ( {p}_{t} ) .$$

$${p}_{t} = \{ \begin{matrix}p & if y = 1 \\ 1 - p & otherwise\end{matrix} .$$

where

When an example is misclassified and pₜ is small, the modulating factor is near 1 and the loss is unaffected. As pₜ→1, the factor goes to 0 and the loss for well-classified examples is down-weighted. The focusing parameter γ may smoothly adjust the rate at which easy examples are down-weighted. When γ=0, focal loss (“FL”) is equivalent to LogLoss, and as γ is increased the effect of the modulating factor is likewise increased. The above loss function optimized training for machine learning fraud detection model 118.

The feature selection model 116 may use a model ensemble approach for a first model trained with a first hyperparameter and a second model trained with a second hyperparameter, so that the ensemble model enhances stability. Features of the first and second models may be scored. Weighted averages of the scores may be calculated by feature selection model 116. Machine learning fraud detection model 118 may use the weighted averages when calculating an actual or test case score.

Feature selection model 116 may select amongst one or more features including f_bene_age_brie_dl, f_bene_recency_brie_dl, f_bene_age_global_brie_dl, f_bene_recency_global_brie_dl, f_bene_max_payment_ratio_global_brie, f_bene_avg_payment_ratio_brie, f_benebnk_fraud_frac_dl, f_cntry_fraud_frac_dl, f_cntry_percent90_ratio_brie, f_bene_trx_cnt_global_brie_dl, f_bene_nclients_brie_dl, f_bene_max_trx_amt_brie_dl, f_msci_fraud_ratio_dl, f_msciclass_amt_percent90_ratio_brie, f_msciclass_amt_percent50_ratio_brie, f_cntry_percent90_ratio_brie, f_entry_percent50_ratio_brie, f_benebnk_percent90_ratio_brie, f_benebnk_percent50_ratio_brie, f_bene_z_score_brie, f_min_bene_trx_cnt_30_global_brie, and f_max_bene_trx_cnt_30_global_brie. These functions are discussed further below.

Feature f_bene_age_brie_dl may be the time difference between the current transaction time and the first time the beneficiary has received any transaction in one year prior to the API call date by trust application 104. This feature is calculated as the maximum of the bene_age calculated from beneficiary module 108 and transaction data module 112.

Feature f_bene_recency_brie_dl may be the time difference between the current transaction time and the most recent prior time the beneficiary has received any transaction in one year prior to API call date by trust application 104. This feature is calculated as the minimum of the bene_recency calculated from beneficiary module 108 and transaction data module 112.

Feature f_bene_age_global_brie_dl may be the time difference between the current transaction time and the first time the beneficiary has received any transaction in two years prior to API call date by trust application 104. This feature is calculated as the maximum of the bene_age_global calculated from beneficiary module 108 and transaction data module 112.

Feature f_bene_recency_global_brie_dl may be the time difference between the current transaction time and the most recent prior time the beneficiary has received any transaction in one year prior to the transaction date. This feature is calculated as the minimum of the bene_recency_global calculated from beneficiary module 108 and transaction data module 112.

Feature f_bene_max_payment_ratio_global_brie may be the ratio of the transaction amount and the maximum amount of the prior transactions in two years.

Feature f_bene_avg_payment_ratio_brie may be the ratio of the transaction amount and the average amount of the prior transactions in one year.

Feature f_benebnk_fraud_frac_dl may be the ratio of the total number of fraudulent transactions sent to a beneficiary bank and the total number of previously sent transactions to that beneficiary bank over one prior year before the transaction date. This feature is calculated using data from transaction data module 112.

Feature f_cntry_fraud_frac_dl may be the ratio of the total number of fraudulent transactions sent to a country and the total number of previously sent transactions to that country over one prior year before the transaction date”. This feature is calculated using transaction data module 112.

Feature f_cntry_percent90_ratio_brie may be the ratio of the transaction amount and the 90th percentile of the aggregate amounts received by the underlying country over the prior one-year transactions.

Feature f_bene_trx_cnt_global_brie_dl may be the total number of the prior transactions the underlying beneficiary account has received two years prior to the transaction date. This feature is calculated as the maximum of the bene_trx_cnt_global calculated from beneficiary module 108 and transaction data module 112.

Feature f_bene_nclients_brie_dl may be the total number of unique clients that the underlying beneficiary account has received transactions from within one year prior to the transaction date. This feature is calculated as the maximum of the bene_nclients calculated from beneficiary module 108 and transaction data module 112.

Feature f_bene_max_trx_amt_brie_dl may be the maximum of the amount the underlying beneficiary account has received within one year prior to the transaction date. This feature is calculated as the maximum of the bene_max_trx_amt calculated from beneficiary module 108 and transaction data module 112.

Feature f_msci_fraud_ratio_dl may be the ratio of the total number of fraudulent transactions sent to a group of countries sharing an economic robustness as the country code in the fraudulent transaction and the total number of previously sent transactions to that country code over one prior year before the transaction date. This feature is calculated using transaction data module 112.

Feature f_msciclass_amt_percent90_ratio_brie may be the ratio of the transaction amount and the 90th percentile of the aggregate amounts received by the group of country codes over the prior one-year transactions.

Feature f_msciclass_amt_percent50_ratio_brie may be the ratio of the transaction amount and the 50th percentile of the aggregate amounts received by the group of country codes over the prior one-year transactions.

Feature f_cntry_percent90_ratio_brie may be the ratio of the transaction amount and the 90th percentile of the aggregate amounts received by the underlying country over the prior one-year transactions.

Feature f_cntry_percent50_ratio_brie may be the ratio of the transaction amount and the 50th percentile of the aggregate amounts received by the underlying country over the prior one-year transactions.

Feature f_benebnk_percent90_ratio_brie may be the ratio of the transaction amount and the 90th percentile of the aggregate amounts received by the underlying beneficiary bank over the prior one-year transactions.

Feature f_benebnk_percent50_ratio_brie may be the ratio of the transaction amount and the 50th percentile of the aggregate amounts received by the underlying beneficiary bank over the prior one-year transactions.

Feature f_bene_z_score_brie may be a z-score of the transaction amount for a beneficiary. Mean and standard deviation may be calculated for the transaction amounts the beneficiary account has received over one year prior to the transaction date.

Feature f_min_bene_trx_cnt_30_global_brie may be the minimum number of total transactions the underlying beneficiary has received in each 30 days in the past two years prior to the API call by trust application 104.

Feature f_max_bene_trx_cnt_30_global_brie may be the maximum number of total transactions the underlying beneficiary has received in each 30 days in the past two years prior to the API call by trust application 104.

In some embodiments, machine learning fraud detection model 118 may generate new features to add or remove from the list of features to improve an efficiency and effectiveness of machine learning fraud detection model 118. The new features may be based off the existing features including iterating through changes in parameters to include a larger or shorter time period or a different percentile.

Model tester 114 may test machine learning fraud detection model 118 may use more than one metric including one or more of an overall aera under receiver operating characteristics, a false positive rate at 60% true positive rate, and a high-risk precision. The metrics may reveal one or more of riskiness of beneficiaries, a cumulative percentage of detected bad actors, and/or a level of confidence. Model tester 114 may leverage Piece-wise Cubic Hermite Interpolating Polynomial (PCHIP) approach to interpolate scores at the selected anchor points.

Data lake 110 may be one or more databases stored on a local computer, on a cloud, or as part of a memory on a computer system. Data lake 110 may be managed internally or by a third party.

Trust/distrust database 120 may be one or more databases stored on a local computer, on a cloud, or as part of a memory on a computer system. Trust/distrust database 120 may be encrypted.

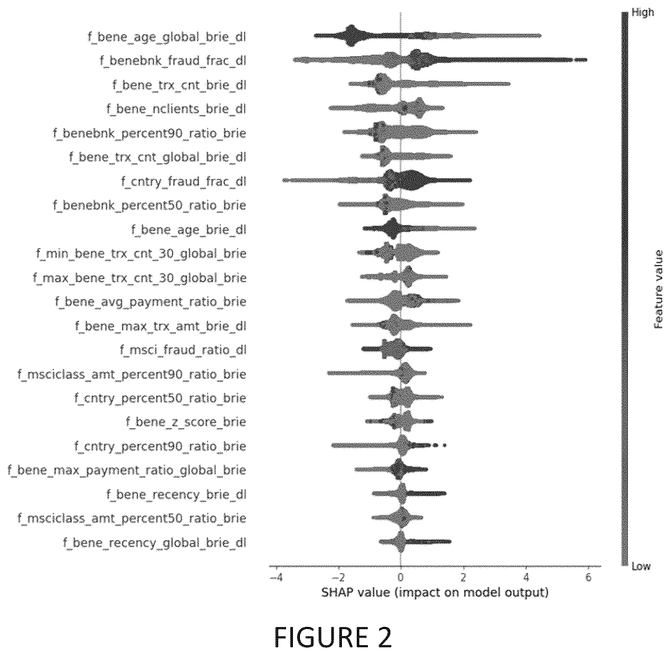

FIG. 2 is a SHAP model illustrating feature importance for a machine learning model, in accordance with some embodiments.

Each of the features may be graphed based on feature value and SHAP value described as an impact on a machine learning model output. FIG. 2 may illustrate a beeswarm plot. The SHAP beeswarm plot may display an information-dense summary of how the top features in a dataset impact the model's output. Each instance the given explanation is represented by a single dot on each feature row. The darkness indicator dictates the classification with dark being more likely fraudulent and lighter representing more genuine. In a machine learning model, the top feature is the beneficiary global age with a young age being the top factor increasing the risk of the beneficiary with the big cluster of dark.

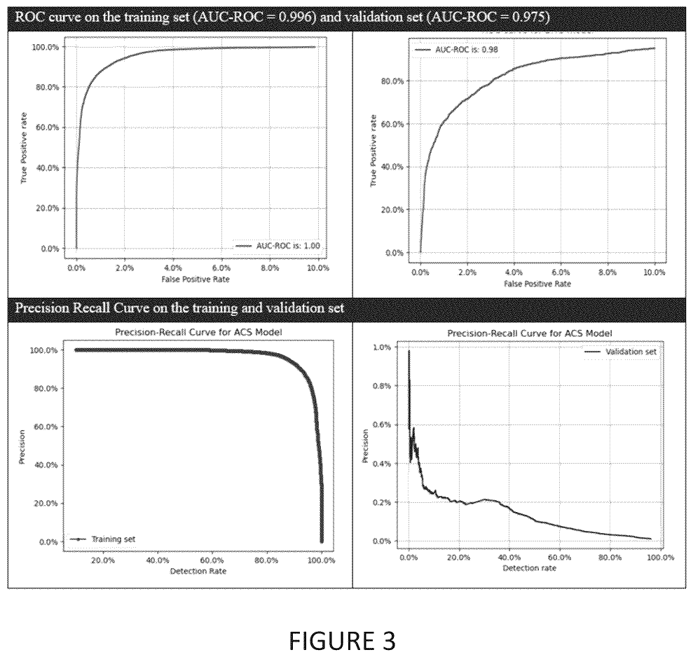

FIG. 3 are training and validation set charts of a machine learning model, in accordance with some embodiments.

A machine learning model may be tested and validated based on testing and validation sets respectively. The results may be tested to measure area under the curve (“AUC”) receiver operator characteristics (“ROC”) and/or precision recall. Based on the results, the machine learning model may be improved by incorporating feedback from the charts, for example by selecting data points of optimal models (e.g., the desired ROC curve or desired precision recall curve) and adjusting parameters or weighting of parameters until the charts more closely reflect the optimal models. A true positive rate and a false positive rate may be measured for the ROC curves, and a precision rate and a detection rate may be measured for the precision recall curve. The “ACS Model” of the figures is the account confidence score model that may be a machine learning model consistent with disclosed embodiments.

In some embodiments, the true positive rate may be used by the machine learning model to calibrate raw scores to the final confidence scores. To calibrate the machine learning model, one or more pegging points may be used to adjust the raw confidence score to a final confidence score. The pegging points may be distributed through a range of confidence scores, for example, 0%, 60%, 95%, and 100%. If full mapping is desired, model tester may use the piece-wise cubic hermit interpolating polynomial approach to interpolate scores at the selected anchor points.

In the displayed charts of FIG. 3, a training set is on the left and a validation set is on the right. During the training stage of a machine learning model, particularly in fraud detection, the precision-recall curve often start at precision close to 100% at the beginning of recall. This is done because the training set is typically down-sampled to increase the fraud rate, allowing the model to focus more on learning the characteristics of fraudulent transactions. For example, the model might be trained using a dataset where the fraud rate is artificially set at 5%, significantly higher than the natural occurrence. By down-sampling genuine transactions (sampling a small % of genuine transactions while keeping all fraudulent transactions), the model is exposed to a much lower proportion of genuine cases, which can lead to an artificially high precision. However, this is not the case for the validation and test sets, which are not down-sampled and retain their original size and distribution, with a fraud rate of about 0.03%, reflecting real-world conditions. Consequently, the precision-recall curve for validation and test sets may not exhibit the same shape, and precision may not reach a high percentage. The y-axis between the two plots differs due to these variations in fraud rates, resulting in much lower precision in the validation set compared to the training set. This discrepancy highlights the importance of evaluating model performance on validation and test sets to ensure that the model generalizes well to unseen data and accurately reflects the true distribution of fraud in a real-world setting.

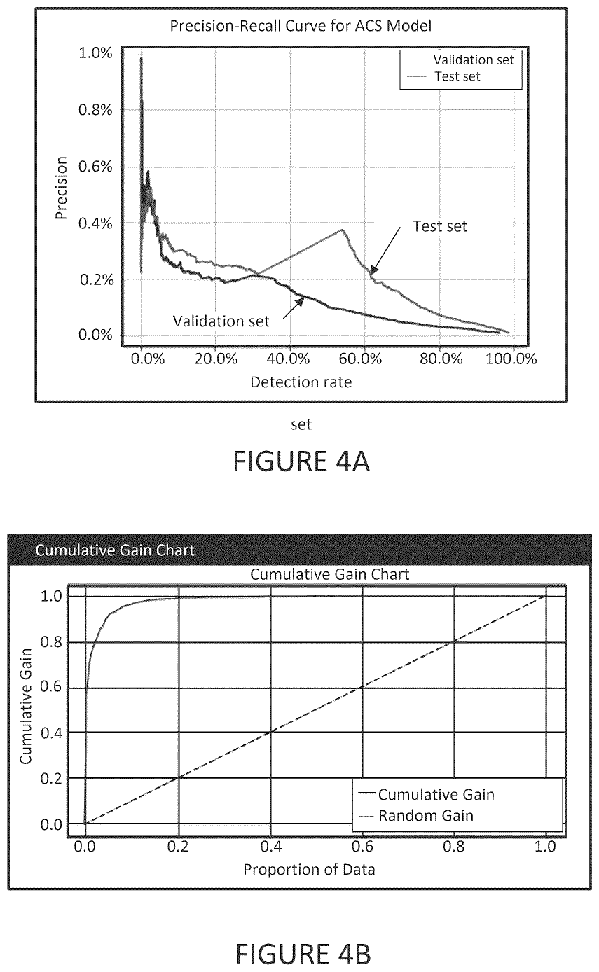

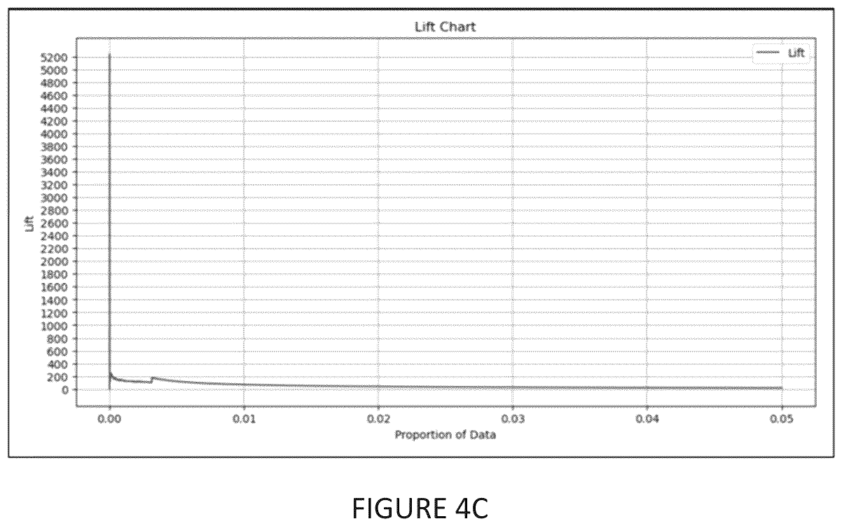

FIG. 4A is a training and validation set chart of a machine learning model, in accordance with some embodiments.

This chart highlights the discriminatory power of the machine learning model. It displays that an overwhelming majority of beneficiaries have high confidence scores as expected because the low confidence fraud ratio is nearly 2000× larger than the high confidence score band, and the low confidence score range is only utilized for roughly 1 in 200 transactions within the test set. Additionally, low confidence precision is 0.24% (Over 1 out of 500 beneficiaries with a “low confidence” classification will be fraudulent).

FIG. 4B is a cumulative gain chart of a machine learning model, in accordance with some embodiments.

A tester module may evaluate the performance of a machine learning model that may comprise classification models using a cumulative gain chart as shown in FIG. 4B. This improves fraud detection of machine learning models. The cumulative gain chart may include a plot of a percentage of the actual positive instances (e.g., fraudulent transactions) captured against a percentage of the population, ranked by the predicted probability of being positive. In the context of fraud detection, a well-performing model will show a steep initial gain, indicating that the top-ranked transactions (those the model predicts most likely to be fraudulent) indeed capture a high proportion of actual fraudulent cases. A tester module may use the cumulative gain chart to determine effectiveness of the machine learning model and adjust features or weighting of features. Thus, a machine learning model may improve detection of fraud with limited resources that do not require significant computing power or testing.

FIG. 4C is a lift chart of a machine learning model, in accordance with some embodiments.

A tester module may measure effectiveness of machine learning model comprising a classification model by charting a set of results with a random selection (e.g., fraud cases guessed at random) which may be a baseline as shown in FIG. 4C. A tester module may plot the lift (ratio of the positive instances identified by the machine learning model to positive instances identified by random selection) against a percentage of the population. In fraud detection, the lift chart provides a visual representation of how much more effective the model is at detecting fraud compared to random guessing. A higher lift in the initial segments of the chart indicates that the machine learning model is significantly better at identifying fraudulent transactions in the top-ranked predictions, thus offering a clear advantage in focusing investigative efforts on the most suspicious cases and improving overall fraud detection efficiency.

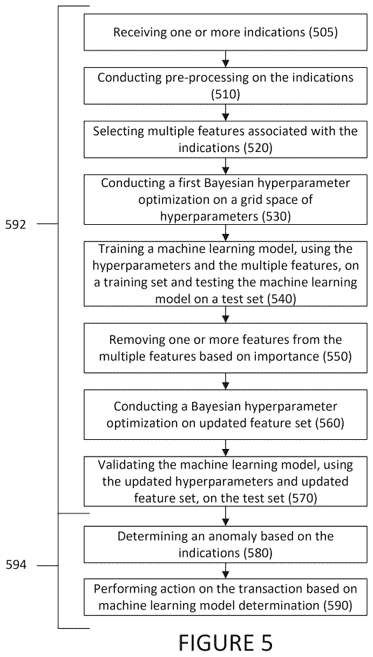

FIG. 5 is a method illustrating contextual recall for machine learning models that execute fraud detection, in accordance with some embodiments.

Step 505 may include receiving, by an application executed by one or more processors, one or more indications. receiving, from an application in operable communication with a user interface, an indication of a proposed beneficiary of a transaction that has not been executed, the transaction being associated with a financial institution. For example, the one or more indications may include a beneficiary account identifier, a beneficiary bank identifier, and/or a beneficiary bank country.

Step 510 may include conducting, by the application, pre-processing on the one or more indications. Pre-processing may include normalizing the indications including, for example, removal of unexpected, delimiters, or special characters. Pre-processing may include inserting portions of the indicators into a number of fields each comprising a set number of characters. Pre-processing may include inserting delimiters or punctuation between fields.

Step 520 may include selecting, by the application, multiple features associated with the indications. Step 520 may include performing a web search for features associated with the indications (e.g., for keywords, for synonyms of keywords, for words or phrases with frequency above a threshold), referencing a database of features accessible by the application and stored on a memory or a cloud, determining one or more categories associated with the indications, and/or determining features from one or more documents associated with the indications, the one or more documents determined from a web search or user input.

Step 530 may include conducting, by the application, a first Bayesian hyperparameter optimization on a grid space of hyperparameters to select hyperparameter values of the hyperparameters. Step 530 may include conducting, by the application, a Bayesian hyperparameter optimization on the grid space, the one or more hyperparameters including an iteration amount, a learning rate, a depth, and a column subsampling. In some embodiments, the method may further include determining, by the application, the hyperparameter values based on a focal loss function.

Step 540 may include training, by the application, a machine learning model executed by one or more processors using the hyperparameters, the hyperparameter values, and the multiple features, the machine learning model being trained on a training set. The training set may be generated by a training module based on the indications. The training set may include one or more verified or predefined sets. In some embodiments, the training set may be generated by the training module with training true indications similar to the received indications and training false indications including training anomalies that include one or more incongruities among the set of training false indications (e.g., an indication is fictional, an indication does not match a fact verifiable by a source document or an aggregate of third party documents, a bank beneficiary country does not match a transaction location, a transaction country does not match a beneficiary bank). The machine learning model may use the multiple features and the hyperparameter values. Step 540 may include testing, by the application, the machine learning model on a test set. The test set may include some of the training set indications and some test set indications. The test set may be generated by a test module based on the indications and/or the training indications. The test set may include one or more verified or predefined sets. In some embodiments, the test set may be generated by the test module with test true indications similar to the received indications and test false indications including test anomalies that include one or more incongruities among the set of test false indications (e.g., a country is a fake country, a bank beneficiary country does not match a transaction location, a transaction country does not match a beneficiary bank).

Step 550 may include removing, by the application, one or more features of the multiple features to form an updated feature set, the one or more features to be removed being determined by the application based on importance based on a SHAPley analysis of importance of each feature. Step 550 may include adding and/or removing, by the application, one feature of the multiple features based on importance. The SHAPley analysis may result in higher performance of the machine learning model that may be verified on a verification set. The verification set may include some of the training set indications, some of the test set indications, and some verification set indications. The verification set may be generated by a verification module based on the indications, the training indications, and/or the verification indications. The verification set may include one or more verified or predefined sets. In some embodiments, the verification set may be generated by the verification module with verification true indications similar to the received indications and verification false indications including verification anomalies that include one or more incongruities among the set of verification false indications.

Step 560 may include conducting, by the application, a second Bayesian hyperparameter optimization on the grid space to select updated hyperparameter values associated with the hyperparameters. Step 560 may include conducting, by the application, a Bayesian hyperparameter optimization on the grid space including one or more hyperparameters including the iteration amount, the learning rate, the depth, and the column subsampling.

Step 570 may include validating, by the application, the machine learning model based on the hyperparameter values and the updated feature set. Step 570 may include validating, by the application, the machine learning model based on the verification set.

Step 580 may include determining, by the machine learning model, an anomaly based on the indications. Step 580 may include determining, by the machine learning model, an anomaly based on the indications. The anomaly may be determined based on one or more indications including a false or fictional indication or a mismatch of at least two indications.

Step 590 may include performing an action on the transaction based on the machine learning model determination. In some embodiments, the machine learning model determination may be used by the application to block the transaction based on an identification of fraud by the machine learning model. In some embodiments, the machine learning model determination may be used by the application to allow the transaction based on an identification of fraud by the machine learning model. In some embodiments, the action may be determined based on a value of the machine learning determination. The application may reference a database of machine learning determinations and associated actions to determine the action. For example, if the determination is a relatively high score, the application may allow a transaction, if the determination is a medium score, the application may require more information by starting a communication channel (e.g., automated phone call, text, application communication via an application programming interface (“API”)) to an electronic device (e.g., for electronic device verification information or a two-factor authentication), and if the determination is a low score, the application may block a transaction, send alerts to one or more associated recipients, financial institution, and/or transferors, and/or generate a message based on the determination.

In some embodiments, steps in portion 592 may be a training and/or a generation of a machine learning model. Steps in portion 594 may be a performance or a production of the machine learning model.

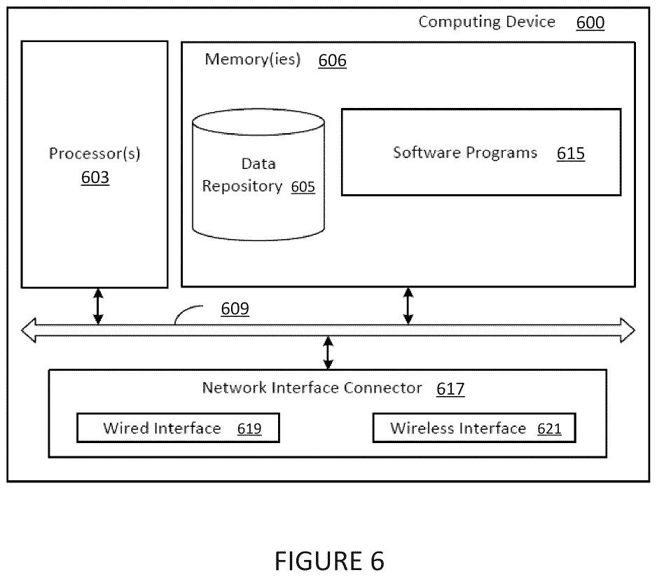

FIG. 6 is a block diagram of a computing device for implementing certain aspects of the present disclosure. FIG. 6 depicts exemplary computing device 600. Computing device 600 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 600.

Computing device 600 includes a processor 603 coupled to a memory 606. Memory 606 may include volatile memory and/or persistent memory. The processor 603 executes computer-executable program code stored in memory 606, such as software programs 615. Software programs 615 may include one or more of the logical steps disclosed herein as a programmatic instruction, which can be executed by processor 603. Memory 606 may also include data repository 605, which may be nonvolatile memory for data persistence. The processor 603 and the memory 606 may be coupled by a bus 609. In some examples, the bus 609 may also be coupled to one or more network interface connectors 617, such as wired network interface 619, and/or wireless network interface 621. Computing device 600 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, by an application executed by one or more processors, indications comprising a beneficiary account identifier, a beneficiary bank identifier, and/or a beneficiary bank country;
conducting, by the application, pre-processing on the beneficiary account identifier, the beneficiary bank identifier, and/or the beneficiary bank country;
selecting, by the application, multiple features associated with the beneficiary account identifier, the beneficiary bank identifier, and/or the beneficiary bank country;
conducting, by the application, a first Bayesian hyperparameter optimization on a grid space of hyperparameters to select hyperparameter values of the hyperparameters, wherein the hyperparameters includes an iteration amount;
training, by the application, a machine learning model executed by one or more processors using the multiple features and the hyperparameter values, the machine learning model being trained on an indication training set;
removing, by the application, one or more features of the multiple features to form a final feature set, the one or more features to be removed being determined by the application based on a SHAPley analysis of importance of each feature;
conducting, by the application, a second Bayesian hyperparameter optimization on the grid space to select updated hyperparameter values associated with the hyperparameters;
validating, by the application, the machine learning model using the updated hyperparameter values and the final feature set on a validation set;
determining, by the machine learning model, a fraud based on the indications; and
blocking, by a transaction application in communication with the application, the transaction based on the machine learning model determination.

2. The method of claim 1, further comprising determining, by the application, the hyperparameter values based on a focal loss function.

3. The method of claim 2, wherein the focal loss function is calculated based on the following equation:
$$F L ( {p}_{t} ) = - {( 1 - {p}_{t} )}^{γ} log ( {p}_{t} ) .$$
$${p}_{t} = \{ \begin{matrix}p & if y = 1 \\ 1 - p & otherwise\end{matrix} .$$
where
and γ is a focusing parameter that adjusts the rate at which examples are down-weighted.

4. The method of claim 1, wherein the hyperparameters include a learning rate.

5. The method of claim 1, wherein the hyperparameters include a depth.

6. The method of claim 1, wherein the hyperparameters include a column subsampling.

7. The method of claim 1, further comprising monitoring a performance of the machine learning model based on a set of indications, and determining to retrain the machine learning model if a threshold of 0.8 is exceeded for an area under a curve of the receiver operating characteristics.

8. The method of claim 1, further comprising monitoring a performance of the machine learning model based on a set of indications, and determining to retrain the machine learning model if a difference of interpolated determinations differences from a known data plot at one or more peg points exceeds a threshold for a true positive rate.

9. The method of claim 8, wherein the interpolation is determined using a Piece-wise Cubic Hermite Interpolating Polynomial at the one or more peg points.

10. A method comprising:
receiving, by an application executed by one or more processors, one or more indications;
conducting, by the application, pre-processing on the indications;
selecting, by the application, multiple features associated with the indications;
conducting, by the application, a first Bayesian hyperparameter optimization on a grid space of hyperparameters to select hyperparameter values of the hyperparameters, wherein the hyperparameters includes an iteration amount;
training, by the application, a machine learning model executed by one or more processors based on the multiple features and the optimization hyperparameter;
removing, by the application, one or more features of the multiple features to form a final feature set, the one or more features to be removed being determined by the application based on importance based on a SHAPley analysis of importance of each feature;
conducting, by the application, a second Bayesian hyperparameter optimization on the grid space to select hyperparameter values associated with the hyperparameters;
validating, by the application, the machine learning model based on the hyperparameter values and the final feature set;
determining, by the machine learning model, an anomaly based on the indications; and
performing, by the application, an action associated with the machine learning model determination.

11. The method of claim 10, further comprising determining, by the application, the hyperparameter values based on a focal loss function.

12. The method of claim 11, wherein the focal loss function is calculated based on the following equation:
$$F L ( {p}_{t} ) = - {( 1 - {p}_{t} )}^{γ} log ( {p}_{t} ) .$$
$${p}_{t} = \{ \begin{matrix}p & if y = 1 \\ 1 - p & otherwise\end{matrix} .$$
where
and γ is a focusing parameter that adjusts the rate at which examples are down-weighted.

13. The method of claim 10, wherein the hyperparameters includes a learning rate.

14. The method of claim 10, further comprising monitoring a performance of the machine learning model based on a set of indications, and determining to retrain the machine learning model if a threshold of 0.8 is exceeded for an area under a curve of the receiver operating characteristics.

15. The method of claim 10, further comprising monitoring a performance of the machine learning model based on a set of indications, and determining to retrain the machine learning model if a difference of interpolated determinations differences from a known data plot at one or more peg points exceeds a threshold for a true positive rate, wherein the interpolation is determined using a Piece-wise Cubic Hermite Interpolating Polynomial at the one or more peg points.
